(19) United States
(12) Patent Application Publication
(10) Pub. No.: US 2025/0098588 A1
(43) Pub. Date: Mar. 27, 2025

(54) PICK-UP ATTACHMENT FOR A PREFERABLY SELF-PROPELLED FORAGE HARVESTER

(71) Applicant: Carl Geringhoff GmbH & Co. KG, Ahlen (DE)

(72) Inventors: André HEMMESMANN, Sassenberg (DE); Andreas LEUDERALBERT-BOWE, Gronau (DE); Reimer Uwe TIESSEN, Oldenburg (DE); Holger STRUNK, Wadersloh (DE); Cristiano SCHWARTZ, Ahlen (DE)

(73) Assignee: Carl Geringhoff GmbH & Co. KG, Ahlen (DE)

(21) Appl. No.: 18/290,841

(22) PCT Filed: Jul. 19, 2022
(86) PCT No.: PCT/DE2022/100523

§ 371 Date: Jan. 22, 2024

(30) Foreign Application Priority Data
Aug. 5, 2021 (DE) 10 2021 120 455.0

(51) Int. Cl. A01D 89/00; A01B 73/04

(52) U.S. Cl. CPC A01D 89/002; A01B 73/042

(57) ABSTRACT

A pick-up attachment for a preferably self-propelled forage harvester includes a pick-up rotor with pick-up implements (for picking up crops from the ground, wherein the pick-up rotor is assembled from several segments joined to one another in at least partly articulated relationship for adaptation to the contours of the ground.

The invention relates to a pick-up attachment for a preferably self-propelled forage harvester, comprising a pick-up rotor with pick-up implements for picking up crops from the ground.

Forage harvesters are agricultural machines used for the harvesting and the gathering of crops, the cutting of crops to short parallel lengths and the conveying of the harvested forage into containers or separate vehicles. Typical crops are grasses, legumes, mixtures and/or crops grown in rows, such as corn or millet. The harvested forage can be stored either by silage or drying or fed directly to the livestock. The forage harvester may harvest the crop directly by cutting in full width or from single or multiple rows, or by gathering from the swath. Forage harvesters may be mounted on the tractor or towed by a tractor, or may be self-propelled.

A harvesting attachment is a normally detachable device for picking up the crop in the forage harvester. A pick-up attachment as a forage harvester is especially a device for picking up previously cut crops. Such crops may be deposited in swaths or rows.

Known pick-up attachments for self-propelled forage harvesters comprise a rigid roller-like pick-up rotor with pick-up implements for picking up crops from the ground. This rigid pick-up rotor is joined to the machine frame of the pick-up attachment securely, in other words almost likewise rigidly, or in reciprocating relationship, or is attached to it. Such pick-up rotors are guided over the ground by guide elements, which are mounted laterally beside the pick-up rotor and in particular are feeler wheels or feeler skids. The roller-like pick-up rotor then describes a rigid straight line, which extends between the two guide elements. The pick-up rotors may have a steered or a non-steered tine guide. Beyond that, pick-up attachments are known with a rigid or a foldable machine frame, which has a pick-up rotor disposed on it.

In the meantime, self-propelled forage harvesters have attained an engine power of greater than 1000 HP. In parallel with the engine power, the throughput capacity of the forage harvesters has also been increased. Besides the high engine power and throughput capacities needed for corn silage, the harvesting capacity is also an important factor in grass silage for high fodder quality. After being mowed, the meadows and fields must be cleared within a short time window, so that the green fodder, for example, can be ensilaged with optimum dry substance content.

In order to be able to take advantage of the high throughput capacities of the forage harvesters, it is necessary to further increase the picking-up capacity of the pick-up attachments.

In principle, the following methods would be associated with disadvantages with respect to increasing the picking-up capacity of the pick-up attachment for harvesting green fodder.

On the one hand, any increase of the working width of the pick-up attachment would certainly enhance the picking-up capacity, but broader pick-up attachments would soon exceed the legally permissible total width for a road transport. Beyond that, especially correspondingly broader rigid pick-up rotors in such pick-up attachments are unsuitable in particularly rugged terrain, which therefore is not smoothly contoured but instead has varying heights, depths, irregularities or shapes across the width of the pick-up rotor. Under these conditions, especially also the guide elements disposed only laterally beside an inherently rigid pick-up rotor, namely wheels, feeler wheels, rollers or feeler skids, which guide the rigid pick-up rotor over the ground, behave disadvantageously, since they are outside the effective working width of the pick-up attachment.

In order to take the foregoing into account, the pick-up attachment must be guided higher than usual, and so the pick-up implements, especially rake tines, no longer reach the turf, thus leading to harvest losses, since harvest material is not gathered from depressions of the terrain, or the pick-up attachment must be guided deeper than usual, whereby the pick-up implements, especially rake tines, comb aggressively through the ground or the turf, leading to massive fodder soiling and thus reduction of fodder quality, damage to the turf and increased mechanical wear of both the pick-up attachment and even the fodder harvester, since copious dirt, especially sand and soil are also picked up.

On the other hand, as an almost investment-neutral alternative, an increase of the working speed of forage harvesters could enhance the picking-up capacity, but this would also be accompanied by the following negative side effects. The drivers of forage harvesters and transfer vehicles need a much higher level of concentration, so that the exhaustion limit is reached much sooner. The accuracy of transfer drops off, so that harvest losses occur here due to the misses of transfer to the collecting trailer and a reduction in transport capacity due to uneven filling of the transport vehicles. Furthermore, obstructions and foreign bodies are detected too late, so that an increased danger exists not only of poor fodder quality but also of mechanical breakage. In addition, the fuel consumption of forage harvesters and transfer vehicles increases, since especially the propulsion of forage harvesters no longer operates within its optimum characteristics. On the pick-up attachment itself, the pick-up rotor must turn faster at higher forward speeds, in order to be able reliably to lift the matted crop. A higher speed of revolution leads in turn to greater wear of the tines and strippers, especially in steered tine systems. Thereby the danger of tine breakage increases in turn, and higher operating costs are incurred.

In addition, higher feed rates may lead to the disadvantage that the height guidance of the pick-up attachment on the forage harvester becomes too sluggish above a certain forward speed, and so it can no longer reliably guide the attachment to the ground.

Starting from this prior art, the task underlying the invention is to provide an improved pick-up attachment that in particular overcomes the aforesaid disadvantages and favors the increasing throughout capacities of forage harvesters without having to tolerate negative impacts on operating costs and fodder quality.

This task is accomplished in a pick-up attachment for a preferably self-propelled forage harvester by the features of claim 1. Further developments and advantageous configurations of the invention will become apparent from the dependent claims.

The pick-up attachment according to the invention for a preferably self-propelled forage harvester comprises a pick-up rotor with pick-up implements for picking up crops from the ground and is characterized in that the pick-up rotor is assembled from several segments joined to one another in at least partly articulated relationship for adaptation to the contours of the ground.

By the fact that the pick-up rotor of the pick-up attachment is assembled from several segments joined to one another in at least partly articulated relationship, it is ensured that the pick-up rotor is flexible, whereby it can be adapted to the ground contours. This permits the pick-up rotor, when passing over a depression, to compensate at least partly for the contour of the depression, or conversely, when passing over an elevation, to do likewise for the contour of the elevation. In doing so, the pick-up rotor hangs down, so to speak, at the place in question, or conversely, arches up at the place in question.

By the fact that the pick-up rotor of the pick-up attachment is flexibly constructed, an increase of the working width of the pick-up attachment in order to increase the picking-up capacity is possible. Even with larger working widths, pick-up attachments constructed in this way are suitable in rugged terrain. By the fact that the pick-up rotor in his way adapts to the contour of the terrain, the pick-up rotor and thus the pick-up implements, especially rake tines, can be guided at a distance from the turf that is optimum for picking up the crop.

Thus no harvest losses are suffered, since the harvest material is reliably gathered even from depressions in the terrain. In addition, it is ensured that the pick-up implements, especially rake tines, do not comb aggressively through the turf. Since thereby the turf is protected and no dirt such as sand or soil is picked up, fodder contamination is avoided and the fodder quality is increased. The flexibility of the pick-up rotor therefore ensures high fodder quality together with low harvest losses. In addition, an increased mechanical wear of both the pick-up attachment and fodder harvester is avoided.

Even an increase of the working speed of the fodder harvester and thus of the pick-up attachment is possible due to the flexible pick-up rotor for increasing the picking-up capacity.

Flexible pick-up rotors are known for the so-called belt rakes of RT Engineering GmbH, in which the flexible pick-up rotor is rigidly joined to a transverse conveyor belt. The picked-up material is then fed onto a conveyor belt, which moves in a manner transverse to the travel direction. The conveyor belt then deposits the swath on the desired side. Then the swath can be picked up and further processed, for example with a forage harvester, which is equipped with the pick-up attachment according to the invention. In the said belt rake, the unit comprising pick-up rotor and transverse conveyor belt is linked to the machine frame in reciprocating relationship. In addition, the pick-up rotor is equipped with non-steered and degressive tines. In the pick-up attachment according to the invention, a transverse conveyor belt would be unsuitable for self-propelled forage harvesters.

The pick-up attachment according to the invention has a transverse auger, preferably behind the pick-up rotor and therefore pointing toward the forage harvester, so as to gather together the crop picked up via the pick-up rotor and to deliver it to the forage harvester.

In the pick-up forage harvester according to the invention, it may be of advantage for the pick-up rotor to be flexible over the entire working width. This is ensured by numerous segments joined to one another in articulated relationship. The flexibility of the pick-up rotor over the entire working width permits an optimum picking-up of the crop, even when the pick-up attachment is being guided simultaneously over at least one depression or at least one elevation of the rugged terrain. Thereby a high overall fodder quality is ensured, together with low harvest losses.

It may be advantageous to provide, in a manner distributed over the working width of the pick-up attachment, several guide elements, which take over guidance of the pick-up rotor and/or guide it to the ground. It is preferable to provide no guide elements, such as feeler wheels or feeler skids, which would be disposed laterally beside the pick-up rotor. According to the invention, the absence of provision of such guide elements disposed laterally beside the pick-up rotor is already advantageous for smaller working widths of up to 3 m.

It may be advantageous for the guide elements to be disposed underneath and/or directly behind the pick-up rotor and/or within its effective working width. Thereby the pick-up rotor is able to hug the ground contours of the terrain over its entire working width.

It may be advantageous for the guide elements to be constructed at least partly as sliding disks.

Precisely at higher feed rates, the flexibility of the pick-up rotor together with the guide elements constructed as sliding disks additionally supports the height guidance of the forage harvester. Thus an optimum distance is always ensured between the pick-up implements, especially tines, of the pick-up rotor and the turf.

It may be advantageous when the machine frame of the pick-up attachment can be folded to a predetermined transport width and unfolded to a predetermined working width.

In the folded condition, it is possible to comply with the legally permissible transport widths applicable in different countries. In addition, much larger working widths than those of previous pick-up attachments for forage harvesters can be achieved by the foldable design of the pick-up attachment. The broadening or the increase of working width of the pick-up attachment favors the increasing throughout capacities of the forage harvesters without having to tolerate negative impacts on the operating costs and the fodder quality. The combination of greater working width and an inherently flexible pick-up rotor thus supports high forward speeds and the increased throughput capacities of the modern forage harvesters.

The machine frame of the pick-up attachment can be advantageously provided with a two-piece or multi-piece folding mechanism. In order to be folded together, the flexible pick-up rotor is correspondingly separated into foldable couplings provided for that purpose. In the unfolded condition, the previously separated parts of the flexible pick-up rotor are brought back together via the foldable couplings and joined in such a way that the flexible pick-up rotor can be powered by only one central drive.

It may be advantageous for the pick-up attachment to have a transport width that corresponds to the working width, which is 3 m up to at most 4.50 m.

It may be advantageous for the pick-up attachment in the folded condition to have a transport width that is the maximum legally permissible, preferably 3 m, and in the unfolded condition to have a working width that is larger than the transport width, preferably 6 m.

It may be advantageous for the pick-up rotor to be designed as a non-steered pick-up rotor with preferably degressively arranged pick-up implements, preferably degressively arranged tines.

In the non-steered design, the tines extend along a circular trajectory and can rotate around a fixed axis of rotation. In contrast, in the steered design, the tines would be able, in addition to the circumferential movement, to tilt and/or be extended and retracted, while the said circumferential trajectory often deviates from the circular form.

The tines are spring tines, which have the form of a torsion spring with elongated legs as a distinguishing feature. The spring tines may be constructed as double torsion springs.

Degressive means that the legs of the tines or spring tines are angled away or bent counter to the direction of rotation.

Thereby it is ensured that, in case of a massive increase in feed rate, the speed of revolution or circumferential velocity of the pick-up rotor can likewise be greatly increased. The degressively arranged tines then ensure only slight ingress of contamination into the fodder and thereby increase the fodder quality. Furthermore, unlike aggressive tines in steered pick-up rotors, the degressive tines do not tend to gather up stones and other foreign bodies. Thereby down times are reduced and the machine wear is minimized. In other words, the non-steered tine linkage and thereby degressive orientation of the tines positively influence the quality of working at higher feed rates, since this permits higher speeds of revolution of the pick-up rotor with less wear and offers greater protection against picking up foreign bodies and introducing contamination.

For certain service purposes, it may be advantageous for the flexible pick-up rotor to be securely or rigidly joined to the machine frame. The adaptation to the contours of the ground then takes place almost exclusively via the flexibly constructed pick-up rotor.

For other service purposes, it may be advantageous for the flexible pick-up rotor or the machine frame of the pick-up attachment to be combinable or combined with a transverse reciprocating frame, which is disposed on the attachment side, in other words on the pick-up attachment, or on the forager side, in other words on the forage harvester.

It may be advantageous for the flexible pick-up rotor to be linked to the machine frame via an additional reciprocating relative motion. In other words, it may be of advantage for the flexible pick-up rotor to be linked to the machine frame of the pick-up attachment in reciprocating or swinging relationship.

The additional reciprocating relative motion may permit a kind of vertical movement between pick-up rotor and machine frame of the pick-up attachment, so that the adaptation of the pick-up attachment to the ground is significantly improved. This combination may be of advantage above all in very rugged terrain and for very high feed rates, since the known forager-side guide systems for pick-up attachments designed for bearing pressure control approach their limits at high feed rates. In this situation, the reciprocating relative motion permits the pick-up rotor to hug the ruggedness of the ground directly and responsively. Thus the forager-side guide merely has to keep the pick-up attachment in a kind of neutral position relative to the pick-up rotor.

In this situation, the flexibility of the pick-up rotor is enhanced by the reciprocating or swinging up-and-down motion of the linkage. Precisely in very rugged or alpine regions, this leads to even better adaptation of the pick-up attachment to the ground. Most particularly at high feed rates, the reciprocating relative motion permits the pick-up rotor to hug the ruggedness of the ground directly and responsively.

For this purpose, preferably at least one swing arm is provided that is in operative communication with the flexible pick-up rotor or with a guide element joined to the pick-up rotor. For a reciprocating motion, the swing arm is linked to the pick-up motor of the pick-up attachment at one end, i.e. pointing frontward, and joined to the machine frame of the pick-up front attachment at its other end, i.e. pointing rearward, toward the forage harvester.

For further improvement of the kinematics and reduction of the pressure on the ground, the load on the pick-up rotor can be advantageously relieved, for example via the swing arm, by means of load-relieving elements, such as tension or compression springs, for example.

Further features of the invention will become evident from the claims, the figures and the descriptions of the figures. All features and combinations of features mentioned in the foregoing in the description as well as the features and combinations of features mentioned in the following in the description of figures and/or shown in the figures alone are usable not only in the respective indicated combination but also in other combinations or else in stand-alone position.

The invention will now be explained in more detail on the basis of preferred exemplary embodiments and also with reference to the attached drawings, wherein

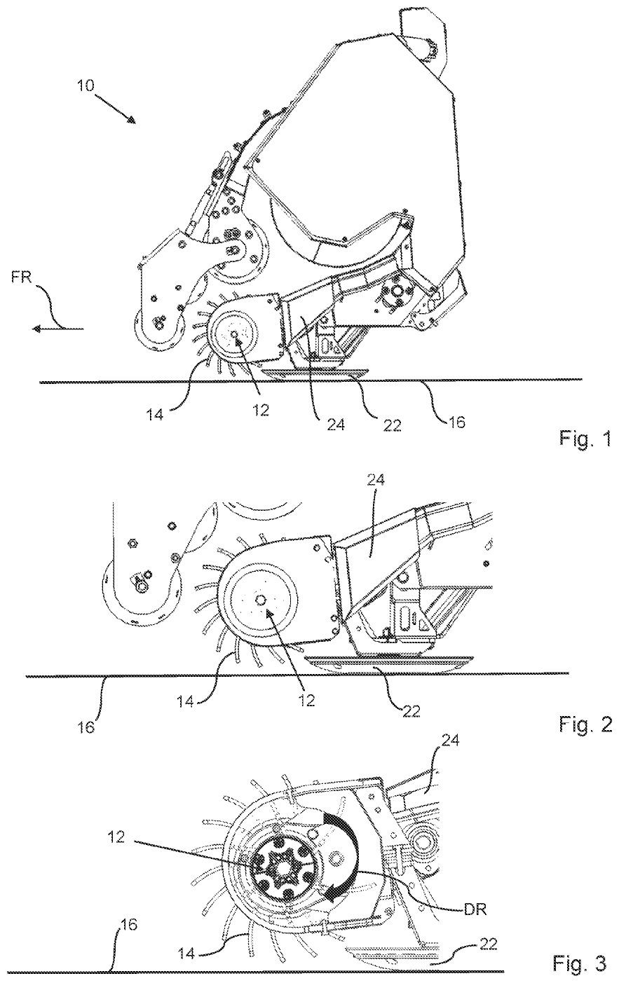

FIG. 1 shows a schematic side view of a first pick-up attachment according to the invention,

FIG. 2 shows a detail view of the pick-up rotor illustrated in FIG. 1 and provided according to the invention together with the linkage of a guide element on the machine frame of the pick-up attachment,

FIG. 3 shows a detail view of the pick-up rotor illustrated in FIG. 2 and provided according to the invention with side cover removed,

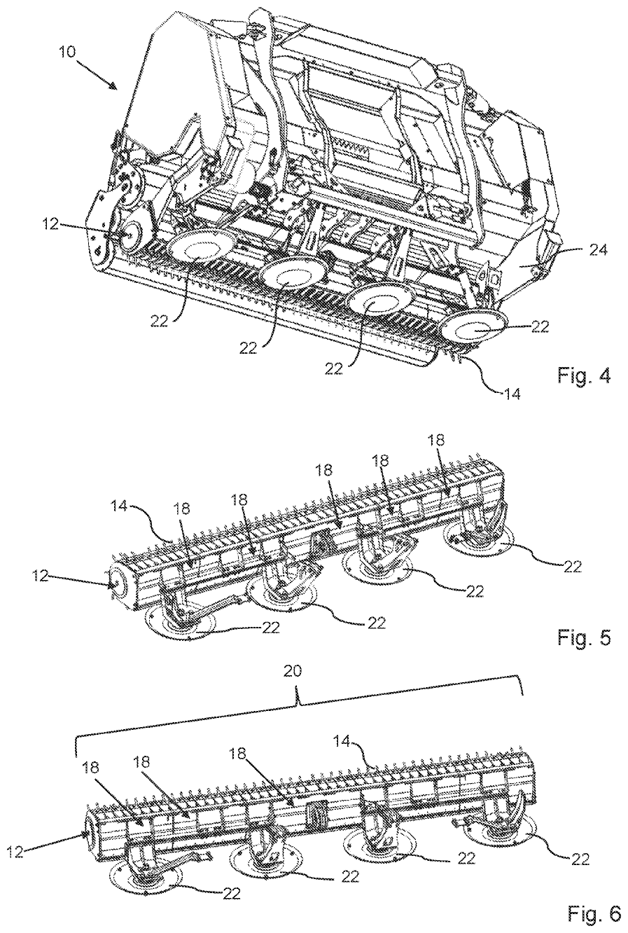

FIG. 4 shows a schematic perspective view from diagonally underneath a first pick-up attachment according to the invention,

FIG. 5 shows a schematic perspective view from diagonally above the pick-up rotor provided according to the invention together with guide elements,

FIG. 6 shows a schematic perspective view from diagonally above the pick-up rotor provided according to the invention together with guide elements,

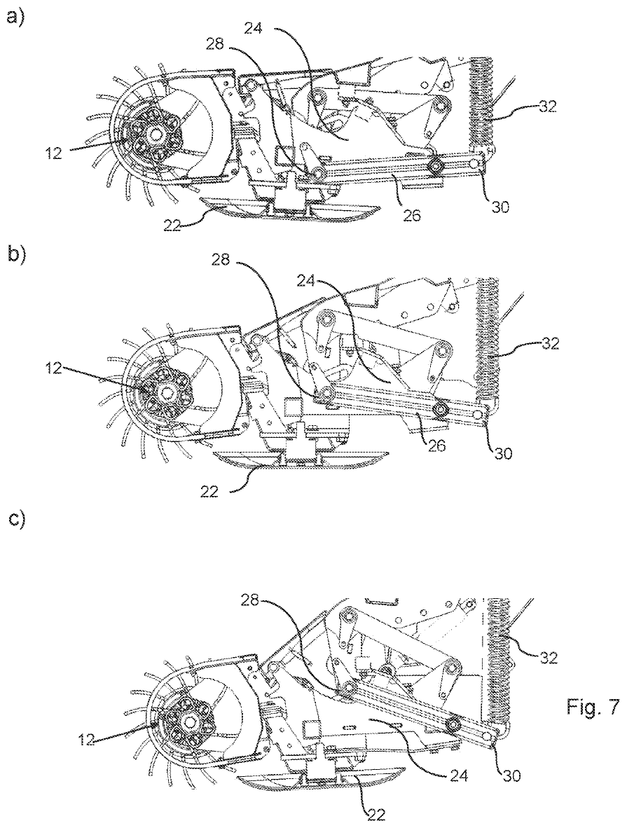

FIG. 7 shows a schematic side view of the pick-up rotor provided according to the invention together with linkage via a guide element on the machine frame of a second pick-up attachment in respectively a) upper position, b) middle position and c) lower position,

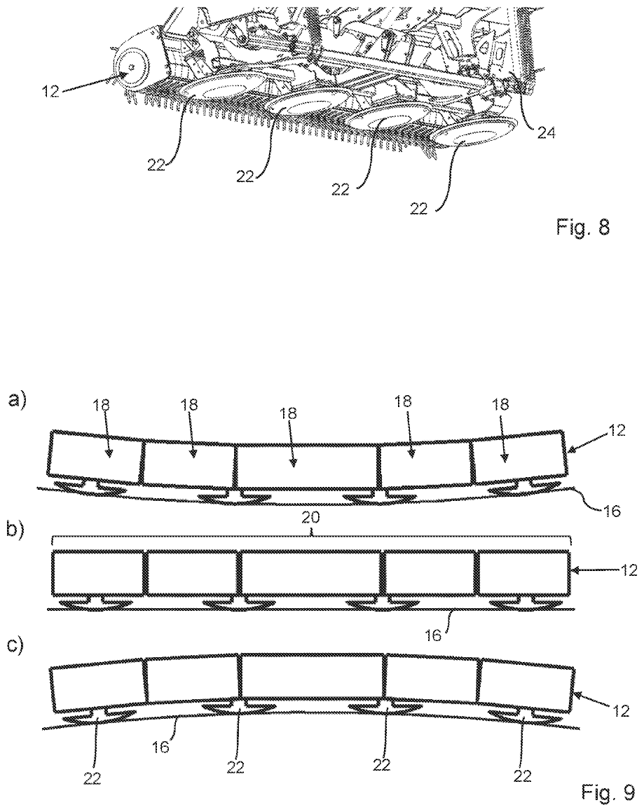

FIG. 8 shows a schematic perspective view from diagonally underneath a second pick-up attachment according to the invention and

FIG. 9 shows a schematic view of the pick-up rotor provided according to the invention in various positions, namely a) while passing through a depression, b) while passing over level terrain and c) while passing over an elevation.

Where like reference symbols are used in FIGS. 1 to 9, they also denote like parts or regions.

FIG. 1 shows a schematic side view of a first pick-up attachment 10 according to the invention for a self-propelled forage harvester, not illustrated here. FIG. 2 shows a detail view of the pick-up rotor 12 illustrated in FIG. 1 and provided according to the invention together with the linkage of a guide element 22 on the machine frame 24 of the pick-up attachment 10. The pick-up attachment 10 has a pick-up rotor 12 with pick-up implements 14 in the form of degressively arranged tines for picking up crops from the ground 16. The travel direction FR or the forward direction of the pick-up attachment 10 is illustrated in FIG. 1 with an arrow. For adaptation to the contours of the ground 16, the pick-up rotor 12 is assembled from several segments 18 joined to one another in at least partly articulated relationship. Individual segments 18 are illustrated by way of example in FIG. 5, 6 or 9. The segments 18 joined to one another in at least partly articulated relationship may have different or equal widths.

The adaptation to the contours of the ground 16 that is achieved due to the flexibility of the pick-up rotor 12 is readily apparent in FIG. 9. FIG. 9 shows a schematic view of the pick-up rotor 12 provided according to the invention in various positions, namely a) while passing through a depression, b) while passing over level terrain and c) while passing over an elevation. In this FIG. 9, it can be readily recognized that the pick-up rotor 12 is flexible over the entire working width 20.

According to the invention, several guide elements 22 in the form of sliding disks are provided in a manner distributed over the working width 20 in order to guide the pick-up rotor 12 to and over the ground 16. As shown in FIG. 1, these guide elements 22 are disposed directly behind the pick-up rotor 12 and, as shown in FIGS. 5 and 6, are disposed within the effective working width 20 of the pick-up rotor 12. FIGS. 5 and 6 respectively show a schematic perspective view from diagonally upward of the pick-up rotor 12 provided according to the invention together with guide elements 22.

FIG. 3 shows a detail view of the pick-up rotor 12 illustrated in FIG. 2 and provided according to the invention, where the side cover has been removed. The pick-up rotor 12 is designed as a non-steered pick-up rotor 12 with degressively arranged tines as pick-up implements 14. The direction of rotation DR of the flexible pick-up rotor 12 is illustrated with an arrow.

FIG. 4 shows a schematic perspective view from diagonally underneath a first pick-up attachment 10 according to the invention. As is also shown in FIG. 1, the pick-up rotor 12 is joined rigidly to the machine frame 24 of the pick-up attachment 10.

In contrast, FIG. 8 shows a schematic perspective view from diagonally underneath a second pick-up attachment 10 according to the invention. In this case, the pick-up rotor 12 is linked in reciprocating or swinging manner on the machine frame 24 of the pick-up attachment 10. In this regard, FIG. 7 shows a schematic side view of the pick-up rotor 12 provided according to the invention together with linkage via a guide element 22 on the machine frame 24 of the second pick-up attachment 10.

It shows a swing arm 26, which is in operative communication with the flexible pick-up rotor 12 or with a guide element 22 joined to the flexible pick-up rotor 12. For a reciprocating or swinging motion, the swing arm 26 is linked to the pick-up rotor 12 of the pick-up attachment 10 at one end 28, i.e. pointing frontward, and joined to the machine frame 24 of the pick-up attachment 10 at its other end 30, i.e. pointing rearward, toward the forage harvester. For further improvement of the kinematics and reduction of the pressure on the ground, the load on the pick-up rotor 12 is relieved via the swing arm 26, by means of load-relieving elements 32, such as tension or compression springs, for example. When the pick-up rotor 12 together with its at least one swing arm 26 is in its lowermost end position, in other words it (12) is passing through a depression, the spring is completely tensioned and the pick-up rotor is thereby relieved to the maximum. When the pick-up rotor together with its at least one swing arm is in its uppermost end position, in other words it (12) is passing over an elevation, the spring is relaxed or less tensioned, so that the pick-up rotor presses with approximately its dead weight on the arable soil.

### LIST OF REFERENCE SYMBOLS

10 Pick-up attachment
12 Pick-up rotor
14 Pick-up implement
16 Ground
18 Segment
20 Working width
22 Guide disk
24 Machine frame
26 Swing arm
28 Frontward pointing end of the swing arm
30 Rearward pointing end of the swing arm
32 Spring element
FR Travel direction
DR Direction of rotation

1. A pick-up attachment (10) for a preferably self-propelled forage harvester, comprising a pick-up rotor (12) with pick-up implements (14) for picking up crops from the ground (16), wherein the pick-up rotor (12) is assembled from several segments (18) joined to one another in at least partly articulated relationship for adaptation to the contours of the ground (16).

2. The pick-up attachment (10) according to claim 1, wherein the pick-up rotor (12) is flexible over the entire working width (20).

3. The pick-up attachment (10) according to claim 1, wherein several guide elements (22) distributed over the working width (20) are provided in order to guide the pick-up rotor (12) to and/or over the ground (16).

4. The pick-up attachment (10) according to claim 1, wherein the guide elements (22) are disposed underneath and/or directly behind the pick-up rotor (22) and/or within its effective working width (20).

5. The pick-up attachment (10) according to claim 1, wherein the guide elements (22) are constructed at least partly as sliding disks.

6. The pick-up attachment (10) according to claim 1, wherein the machine frame (24) of the pick-up attachment (10) can be folded to a predetermined transport width and unfolded to a predetermined working width.

7. The pick-up attachment (10) according to claim 1, wherein the pick-up attachment (10) in the folded condition has a transport width that is the maximum legally permissible, preferably 3 m, and in the unfolded condition has a working width that is larger than the transport width, preferably 6 m.

8. The pick-up attachment (10) according to claim 1, wherein the pick-up attachment (10) has a transport width that corresponds to the working width, which preferably is 3 m to at most 4.50 m.

9. The pick-up attachment (10) according to claim 1, wherein the pick-up rotor (12) is designed as a non-steered pick-up rotor (12) with preferably degressively arranged pick-up implements (14), preferably degressively arranged tines.

10. The pick-up attachment (10) according to claim 1, wherein the pick-up rotor (12) is joined rigidly to the machine frame (24) of the pick-up attachment.

11. The pick-up attachment (10) according to claim 1, wherein the pick-up rotor (12) or the machine frame (24) of the pick-up attachment (10) is combinable with a transverse reciprocating frame, which is disposed on the attachment side, in other words on the pick-up attachment (10), or on the forager side, in other words on the forage harvester.

12. The pick-up attachment (10) according to claim 1, wherein the pick-up rotor (12) is in reciprocating or swinging operative communication with the machine frame (24) of the pick-up attachment (10), preferably via at least one swing arm.
